(19) United States
(12) Patent Application Publication
(10) Pub. No.: US 2016/0138960 A1
(43) Pub. Date: May 19, 2016

(54) METHOD FOR OPERATING A FLOW METER

(71) Applicant: ABB TECHNOLOGY AG, Zuerich (CH)

(72) Inventor: Georg Horst, Northeim (DE)

(21) Appl. No.: 14/937,912

(22) Filed: Nov. 11, 2015

(30) Foreign Application Priority Data
Nov. 14, 2014 (DE) 10 2014 016 820.4

(51) Int. Cl. G01F 25/00; G01F 1/68; G01F 1/58; G01N 3/56; G01F 1/84

(52) U.S. Cl. CPC G01F 25/0007; G01N 3/56; G01F 1/84; G01F 1/58; G01F 1/68

(57) ABSTRACT

A method recognizes wear of a flow meter, involving measuring a baseline of a characteristic of the flow meter, operating under operating conditions, as a configuration, over a calibration period; forming an average value of the baseline, and defining a reference value, an upper limit, and a lower limit, based on the average value, and cyclically measuring the baseline of the characteristic, in a measuring over a measuring period, during wear-causing operation of the flow meter; forming the average value; comparing this average value to the upper and lower limits; and issuing a warning signal when the upper limit is exceeded or when the lower limit is fallen below.

### CROSS-REFERENCE TO RELATED APPLICATIONS

Priority is claimed to German Patent Application No. DE 10 2014 016 820.4, filed on Nov. 14, 2014, the entire disclosure of which is hereby incorporated by reference herein.

### FIELD

The present invention relates to a method for the recognition of changes of the system state of a flow meter with a measuring tube.

### BACKGROUND

The application area of the invention extends to plants, in which the flow rate of fluid streams is to be measured, for example, refineries or manufacturing plants, or oil and gas sources. Due to the direct contact of the flow meter device with the fluid to be measured, but also due to differently caused electronic or mechanical wear, a reduction of the measuring accuracy or also of a total outage of the flow meter can result thereby.

Examples of typical error sources are, amongst others, deposits on the inside of a pipe guided through the flow meter device, which are caused by the fluid, abrasion of material on the inside of such a pipe, in particular by solid parts in the fluid, as well as solid parts or gas bubble parts in the fluid, which falsify the accuracy of the measurement. Independently of these disturbances caused by the fluid, changes of, for example, the inductivity or of the capacity or also of total outages of electronic components can generally occur within the flow meter, for example, due to wear of the components due to age.

In the generally known state of the art it is common to measure an internal characteristic of the flow meter, if necessary, to determine its baseline, and to compare these with limit values in the running operation, which were, for example, set previously during the manufacture or programming of the flow meter. If corresponding extreme values set by these limit values are exceeded or are fallen below, an alarm signal for signaling an error function is usually sent. The internal characteristic can, for example, be an electric current.

It is disadvantageous with the known methods for determining error sources based on internally measured characteristics, that the limit values related to a characteristic are set during the manufacture or programming of the respective flow meter, and are not adapted to special characteristics of, for example, the fluid being passed through or other characteristic properties for a certain application area. Therefore, upper and lower limit values are usually set in the generally known state of the art which deviates strongly from an expectancy value of the characteristic, in order to permit tolerances for possible regular deviations.

### SUMMARY

An aspect of the invention provides a method of recognizing wear of a flow meter, the method comprising: measuring a baseline of a characteristic of the flow meter, operating under operating conditions, as a configuration, over a predefined calibration period; forming an average value, and defining a reference value, an upper limit, and a lower limit, based on the average value, and cyclically measuring the baseline of the characteristic, in a measuring over a predefined measuring period, during a wear-causing operation of the flow meter; forming the average value; comparing the average value to the upper limit and the lower limit; and issuing a warning signal when the upper limit is exceeded or when the lower limit is fallen below.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 a schematization of the method according to invention; and

FIG. 2 a graph of the parameters essential for the method.

### DETAILED DESCRIPTION

An aspect of the invention creates a method with which even small wear already leads to a signalization referring to possible error functions.

An aspect of the invention relates to a method for the recognition of changes of the system state of a flow meter with a measuring tube. Such changes of the system state can be caused by wear, such as abrasion or outage of components, deposits in the measuring tube or changes in the measuring medium, such as solid parts, gas bubble parts. The baseline of an internally measured characteristic of the flow meter which is characteristic for wear is thereby compared to limit values and a warning signal is issued if necessary.

An aspect of the invention includes the technical teachings that a baseline of a characteristic of the flow meter operating under operating conditions is measured in a configuration step over a predefined calibration period, an average value or the standard deviation of the baseline is formed, and a reference value and an upper limit and a lower limit are defined on the basis of the average value or of the standard deviation, and the baseline of the characteristic is thereafter measured cyclically in a measuring step over a predefined measuring period during the wear-causing operation of the flow meter, and its average value or its standard deviation is formed, and this average value or this standard deviation is compared to the upper limit and the lower limit, and a warning signal is issued when the upper limit is exceeded or when the lower limit is fallen below.

An advantage of a method according to the invention consists, among others, in that, by the determination of the average value of the baseline of the characteristic in particular under operating conditions, it is enabled that the limit values essential for an alert are adapted to all plant-specific process conditions, for example, to special characteristics of the fluid. Such process-specific adaptation would not be possible with a setting of the limit values prior installation into the respective process, for example, with the manufacturing or programming of the flow meter.

Preferably, the wear of a flow meter in form of a Coriolis mass flow meter or of a magnetic-inductive flow meter or of a thermal mass meter is diagnosed thereby. The advantage consists in that, among others, these flow meters are susceptible to wear that can be detected by correspondingly selected characteristics.

In a particularly preferred embodiment of the method, as part of the configuration step, the standard deviation of the baseline of the characteristic of the average value is determined over the measuring period, and on basis of the average value and the standard deviation, the reference value and the associated upper limit and the lower limit are defined.

The standard deviation of a magnitude scattering around an expectancy value designates the range, in which the respective magnitude will lie with high probability. For example, with a normal or a Gaussian distribution, statistically about 68% of the respective measured values are within a standard deviation above and below the expectancy value. The advantage of this embodiment consists above all in that not only the average value, but also fluctuations of the characteristic expected during operation are considered during the calculation of the permissible tolerance, thus the upper and lower actuating values.

A further improvement of the invention provides that, as part of the configuration step, the minimum value and maximum value of the baseline of the characteristic are determined during the measuring period, and, on the basis of the average value and the extreme values, thus the minimum and the maximum value, the reference value and the upper limit and the lower limit are defined.

A more accurate characterization of the baseline of the characteristic is enabled thereby, resulting in a further improved adaptation of the limit values to the respective process conditions.

In accordance with further improvements of the invention, the calibration duration can last less than a minute, or between a minute and an hour, or between an hour and a day, or longer than a day up to several months. The advantage of a respective interval results from process-specific circumstances, for example, from the flow rate of the fluid or also from the nature of the characteristic, by which, for example, changes of inductivity or of the capacity of electrical components are made recognizable. The measuring period in the measuring step can thereby correspond to the calibration duration or also be selected differently.

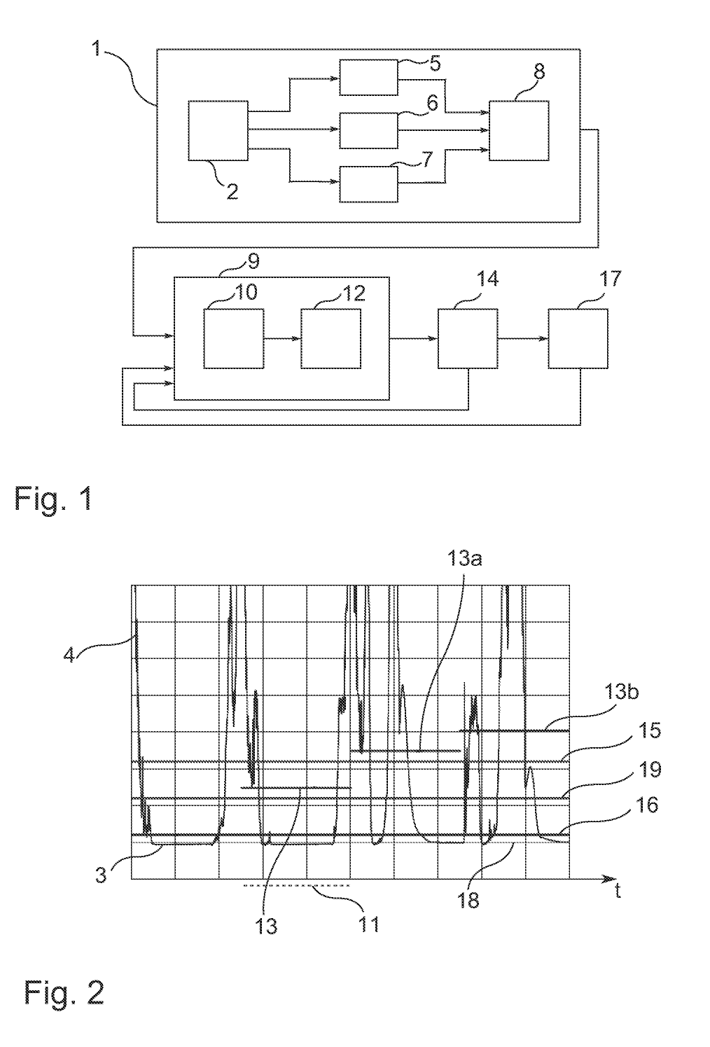

According to FIG. 1, the baseline 3, not shown here further, of a characteristic of 4 of a flow meter is measured in a configuration step 1 within a first process step 2. This characteristic 4 is in particular measured under operating conditions, thus, while the flow meter is built into its assigned process. After the conclusion of the measurement in the process step 2, thus after the expiration of the calibration duration, the average value 13 of the baseline 3 of the characteristic of 4 is calculated in a further process step 5, and the standard deviation of the characteristic 4 of the baseline 3 is calculated in a process step 6 and the minimum and the maximum of the baseline 3 of the characteristic 4 is determined in a process step 7. In a process step 8, an upper limit 15 and a lower limit 16 is calculated by means of the calculated average value 13, the standard deviation and the extremes, which limits define a permitted range of tolerance for the baseline 3 of the characteristic of 4 for this flow meter in its respective process arrangement.

In a measuring step 9, the baseline 3 of the characteristic of 4 is measured within a process step 10 over a measuring period 11, not shown here, whereupon the average value 13 of this baseline 3 is subsequently calculated in a process step 12. In a process step 14, the average value 13 is then compared to the upper limit 15 and the lower limit 16. If the calculated average value 13 lies between the limits 15, 16, the measuring step 9 is implemented again. If the average value 13 lies above the upper limit 15 or below the lower limit 16, then a signal, for example, for alerting technical personnel is sent in a signaling step 17, and thereafter the measuring step 9 is also implemented again.

In FIG. 2, an exemplary graphic evaluation of the measuring step 9 is represented. The characteristic of 4 plotted against a scale, not drawn in, has a baseline 3, which slowly increases along the time axis t to a characteristic amount 18. Furthermore, the reference value 19 calculated in a configuration step 1, together with the upper limit 15 and the lower limit 16 assigned thereto, is plotted against another scale, not drawn in, which define a tolerance interval for the average value 13 of the baseline 3 of the characteristic 4.

A first average value 13 of the baseline 3 is formed over a measuring period 11, which value lies between the upper limit 15 and the lower limit 16. In this representation, the average value 13 is plotted against another scale than the baseline 3. Here, the flow meter thus still operates within permissible parameters. A second average value 13a and a third average value 13b of the increased baseline 3 determined in respectively later time intervals is however above the upper limit 15, whereby an alarm signal would be sent here in practice according to invention.

The invention is not limited to the above-described exemplary embodiment. Rather, modifications thereof are also conceivable, which are also covered by the following claims. It is thus conceivable, for example, that the signaling step 17 exists in the transmission of a digital data packet to an external control unit, for example, for further processing or electronic storage.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMERALS

1 Configuration step

2 Process step

3 Baseline

4 Characteristic

5-8 Process step

9 Measuring step

10 Process step

11 Measuring period

12 Process step

13, 13a, 13b Average value

14 Process step

15 upper limit

16 lower limit

17 Signaling step

18 Characteristic amount

19 Reference value

t Time axis

1. A method of recognizing wear of a flow meter, the method comprising:
measuring a baseline of a characteristic of the flow meter, operating under operating conditions, as a configuration, over a predefined calibration period;
forming an average value, and defining a reference value, an upper limit, and a lower limit, based on the average value, and cyclically measuring the baseline of the characteristic, in a measuring over a predefined measuring period, during a wear-causing operation of the flow meter;
forming the average value;
comparing the average value to the upper limit and the lower limit; and
issuing a warning signal when the upper limit is exceeded or when the lower limit is fallen below.

2. The method of claim 1, wherein the wear of a Coriolis mass flow meter is recognized.

3. The method of claim 1, wherein the wear of a magnetic-inductive flow meter is recognized.

4. The method of claim 1, wherein the wear of a thermal mass meter is recognized.

5. The method of claim 1, comprising, as part of the configuration:
determining a standard deviation of the baseline of the characteristic of the average value over the predefined measuring period; and
defining the reference value, the upper limit, and the lower limit, based on the average value and the standard deviation.

6. The method of claim 1, comprising:
determining the minimum value and the maximum value of the baseline of the characteristic during the predefined measuring period as part of the configuration; and
defining the reference value, the upper limit, and the lower limit, based on the average value and the upper and lower limits.

7. The method of claim 1, wherein the predefined calibration period is shorter than a minute.

8. The method of claim 1, wherein the predefined calibration period is between a minute and an hour.

9. The method of claim 1, wherein the predefined calibration period is between an hour and a day.

10. The method of claim 1, wherein the calibration period is longer than a day.

11. A flow meter configured to determine mass flow of a fluid, the meter comprising:
an electronic control unit including calculation instructions for the executions of the method of claim 1.
